(19) United States
(12) Patent Application Publication
(10) Pub. No.: US 2026/0357098 A1
(43) Pub. Date: Nov. 12, 2026

(54) COATED GLASS FILAMENT

(71) Applicant: SABIC GLOBAL TECHNOLOGIES B.V., Bergen op Zoom (NL)

(72) Inventors: Robert Russell Gallucci, Mount Vernon, IN (US); Gert Boven, Steenbergen (NL); Maria Soliman, Selfkant (DE); Robbert Duchateau, Roostenlaan (NL); Nikhil K. E. Verghese, Richmond, TX (US); Gerard Jan Eduard Biemond, Brunssum (NL); Robert Maria Martin Donners, Brunssum (NL)

(21) Appl. No.: 19/125,848

(22) PCT Filed: Oct. 30, 2023
(86) PCT No.: PCT/EP2023/080225

§ 371 Date: Apr. 30, 2025

(30) Foreign Application Priority Data
Oct. 31, 2022 (EP) 22204760.7
Oct. 31, 2022 (EP) 22204761.5
Dec. 20, 2022 (EP) 22215133.4

(51) Int. Cl. C09D 123/12; C03C 25/30; C09D 7/63; C09D 151/00

(52) U.S. Cl. CPC C09D 123/12; C03C 25/30; C09D 7/63; C09D 151/003

(57) ABSTRACT

A coated glass filament including a glass filament and a coating layer of a polypropylene composition provided directly on the glass filament, wherein the polypropylene composition includes A) a grafted polypropylene grafted with C1) a side chain compound capable of forming hydrogen bond and/or B) a non-grafted polypropylene and C2) a compound capable of forming hydrogen bond, wherein the polypropylene composition eemp es-includes D) a low molecular weight polyethylene having number average molecular weight of at most 5000 g/mol in an amount of less than 10 wt % with respect to the polypropylene composition, wherein the total amount of A) and B) with respect to the polypropylene composition is at least 90 wt %.

### CROSS REFERENCE TO RELATED APPLICATIONS

This application is a National Stage application of PCT/EP2023/080225, filed Oct. 30, 2023, which claims the benefit of European Application No. 22204760.7, filed Oct. 31, 2022; European Application No. 22204761.5, filed Oct. 31, 2022; and European Application No. 22215133.4, filed Dec. 20, 2022; all of which are incorporated by reference in their entireties herein.

### BACKGROUND

The present invention relates to a coated glass filament. The present invention further relates to a multifilament strand comprising a plurality of such coated glass filaments.

Composite materials of glass filaments or fibers and polymers often require high mechanical properties such as flexural and tensile modulus and strength. The mechanical properties of the composite materials are influenced by the adhesion of the polymers to the glass fibers.

It is known to apply a sizing composition to the glass fibers before the polymers are applied in order to improve the adhesion of the polymers to the glass fibers. The sizing compositions can be generally classified into aqueous systems and non-aqueous systems.

The use of aqueous sizing compositions requires a drying step. In practice drying takes a lot of time and therefore, spindles of fibers are prepared which are dried. Aqueous sizings are preferred from a practical point of view, as they are easy to apply and do not require expensive equipment. However, in case of aqueous sizings, drying takes time and energy since it is done in an oven and moreover this leads to inhomogeneous sizing content in the spindles as the glass is dried from the outside.

Non-aqueous sizing compositions do not have this problem related to drying. U.S. Pat. No. 5,998,029 discloses a non-aqueous sizing for glass fibers, comprising a film former miscible with the polymer to be reinforced, the film former having a melting point of 30-60 °C and a viscosity of 75-400 cPs and a silane coupling agent. In Examples IV and V, a sizing for polypropylene glass fiber composites was prepared, comprising VYBAR waxes having Mn of 1500 and 2600 as the film former.

US20080292739 discloses a fiber product for use in forming a preform comprising a heat resistant continuous fiber coated with a thermoplastic sizing composition including a thermoplastic material. In Example 2, a non-aqueous sizing composition based on a lower molecular weight modified polypropylene (a molecular weight of approximately 6500-7000) was applied to continuous glass fibers during their manufacturing. The modified polypropylene was maleic anhydride functional moieties grafted onto polypropylene chains. The modified polypropylene (35% by weight) was melt blended with micro waxes (65% by weight) in order to lower and adjust the processing and application viscosity. The fibers on which the sizing composition was applied were gathered to form a strand and then wound into a package.

Non-aqueous sizing compositions are less preferred since they are not commercially easily available due to the high cost of the raw materials.

It is an object of the invention to provide a coated glass filament in which above-mentioned and/or other problems are solved.

### SUMMARY

Accordingly, the invention provides a coated glass filament comprising a glass filament and a coating layer of a polypropylene composition provided directly on the glass filament, wherein the polypropylene composition comprises
A) a grafted polypropylene grafted with C1) a side chain compound capable of forming hydrogen bond and/or
B) a non-grafted polypropylene and C2) a compound capable of forming hydrogen bond,
wherein the polypropylene composition comprises D) a low molecular weight polyethylene, preferably a low molecular weight polyolefin having number average molecular weight of at most 5000 g/mol in an amount of less than 10 wt % with respect to the polypropylene composition.

### DETAILED DESCRIPTION

The invention further provides a coated glass filament comprising a glass filament and a coating layer of a polypropylene composition provided directly on the glass filament, wherein the polypropylene composition comprises
A) a grafted polypropylene grafted with C1) a side chain compound capable of forming hydrogen bond and/or
B) a non-grafted polypropylene and C2) a compound capable of forming hydrogen bond,
wherein the total amount of A) and B) with respect to the polypropylene composition is at least 90 wt %,
wherein the polypropylene composition comprises D) a low molecular weight polyethylene having a number average molecular weight of at most 5000 g/mol in an amount of less than 10 wt %, less than 5.0 wt %, less than 3.0 wt %, less than 1.0 wt %, less than 0.5 wt % or 0 wt %, with respect to the polypropylene composition.

The coated glass filament according to the invention may be in the form of a single glass filament provided with a coating layer. In this case, the coating layer can be provided over substantially the whole or part of the surface of the glass filament. The coated glass filament may be in the form of a plurality of glass filaments which are (partly) bundled together. In this case, the coating layer may not be present on the parts of the glass filaments in contact with each other.

In some preferred embodiments, the glass filament on which the coating layer is provided has been obtained by recycling a polymer coated glass filament, such as an epoxy coated chopped glass filament. The polymer such as epoxy can be removed from the polymer coated glass filament, for example by burning off the polymer, to obtain a non-coated glass filament. A coating of a polypropylene composition can be provided directly on the non-coated glass filament so obtained to obtain the coated glass filament according to the invention. The use of recycled materials is highly desirable in view of the increase in the sustainability awareness.

The coated glass filament according to the invention comprises a coating layer of a polypropylene composition provided directly on the glass filament. Herein, the term “provided directly” is understood to mean that the polypropylene composition is in direct contact with the filament, i.e. that there are no components present between the surface of the filament and the coating layer, so this means that there are no adhesion promoters, sizings or similar compounds between the polymer composition and the filament. It will thus be appreciated that the “glass filament” on which the coating layer is directly provided is a glass filament which has not been provided with another coating layer of adhesion promoter or sizing.

Due to the absence of sizing composition, problems associated with sizing composition are solved.

The polypropylene composition used according to the invention comprises C1) a side chain compound capable of forming hydrogen bond (as part of the grafted polypropylene) and/or C2) a compound capable of forming hydrogen bond. The presence of C1) and/or C2) in the polypropylene composition improves adhesion to glass fibers. The compounds C1) and C2) have a hydrogen atom or have a functional group which generates a hydrogen atom by (partial) hydrolyzation of the group, which is capable of forming hydrogen bond with the glass filaments. The hydrogen bond improves adhesion of the polypropylene composition to the glass filaments. In some cases, in addition to forming hydrogen bond, condensation reactions between silanol groups on the glass surface and the hydrogen atom can create an ester or ether linkage and thus result in a covalent bond to the glass surface.

Preferably, the polypropylene composition comprises
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof and
B) a non-grafted polypropylene;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof,
B) a non-grafted polypropylene and
C2) a compound selected from oligosilanes (e.g. vinyl-oligosilane, aminopropyl-oligosilane, acryloxy-oligosilane), a copolymer of ethylene and 2-hydroxyethyl methacrylate, epoxy (meth)acrylates, polyamides, an organometallic compound having a pyrophosphate group and combinations thereof; or
B) a non-grafted polypropylene and
C2) a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

### A) Grafted Polyropylene

The polypropylene composition used according to the invention may comprise a grafted polypropylene. The grafted polypropylene is a polypropylene grafted with C1) a side chain compound capable of forming hydrogen bond.

Suitable examples of C1) include anhydrides (e.g. maleic anhydride, itaconic anhydride), oligosilanes (e.g. vinyl-oligosilane, aminopropyl-oligosilane, acryloxy-oligosilane), epoxy (meth)acrylates, polyamides, and combinations thereof. The skilled person knows how to obtain A) by grafting C1) to polypropylene. When C1) is maleic anhydride, the double bond of maleic anhydride is consumed to achieve grafting and succinic anhydride linkages to the polypropylene are made.

An example of epoxy(meth)acrylates is glycidyl methacrylate.

Preferably, C1) comprises anhydrides (e.g. maleic anhydride, itaconic anhydride). Most preferably, C1) comprises maleic anhydride. This result in a good adhesion between the polypropylene composition and the glass filaments.

Preferably, the amount of C1) with respect to the amount of A) is 0.5 to 10 wt %, for example 0.6 to 5.0 wt %, 0.7 to 3.0 wt %, 0.8 to 2.0 wt %.

### C2) Compound Capable of Forming Hydrogen Bond

The polypropylene composition used according to the invention may comprise B) a non-grafted polypropylene and C2) a compound capable of forming hydrogen bond. Preferably, C2) has an unsaturated group which can react with the non-grafted polypropylene to form the hydrogen bond or C2) has a hydrophobic group (e.g. copolymer of ethylene and 2-hydroxyethyl methacrylate (PE-HEMA).

Suitable examples of C2) include oligosilanes (e.g. vinyl-oligosilane, aminopropyl-oligosilane, acryloxy-oligosilane), a copolymer of ethylene and 2-hydroxyethyl methacrylate (PE-HEMA), epoxy (meth)acrylates, polyamides, an organometallic compound having a pyrophosphate group and combinations thereof.

When the polypropylene composition comprises A), C2) is preferably a compound selected from oligosilanes (e.g. vinyl-oligosilane, aminopropyl-oligosilane, acryloxy-oligosilane), a copolymer of ethylene and 2-hydroxyethyl methacrylate (PE-HEMA), epoxy (meth)acrylates, polyamides, an organometallic compound having a pyrophosphate group and combinations thereof.

When the polypropylene composition does not comprise A), C2) is preferably a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

Preferably, C2) is selected from the group consisting of oligosilanes (e.g. vinyl-oligosilane, aminopropyl-oligosilane, acryloxy-oligosilane), an organometallic compound having a pyrophosphate group and combinations thereof. This result in a good adhesion between the polypropylene composition and the glass filaments.

Preferably, C2) comprises a vinyl-oligosilane or an acryloxy-oligosilane, more preferably a vinyl-oligosilane. This result in a particularly good adhesion between the polypropylene composition and the glass filaments.

Oligosilanes were found to have volatility which is low enough to react with polypropylene to achieve the desired effect.

Preferably, the polypropylene composition is free of or is substantially free of an alkoxysilane compound having molecular weight of less than 300 (e.g. γ-aminopropyltriethoxysilane (APTES), γ-glycidoxypropyltrimethoxysilane (GPTMS), γ-methacryloxypropyltrimethoxysilane (MPTMS), vinyltriethoxysilane (VTES)). Preferably, the amount of such alkoxysilane compound having molecular weight of less than 300 with respect to the polypropylene composition is less than 10 wt %, less than 5.0 wt %, less than 3.0 wt %, less than 1.0 wt %, less than 0.5 wt % or 0 wt %.

Preferably, C2) comprises an organometallic compound having a pyrophosphate group, preferably a titanate pyrophosphate compound or a zirconate pyrophosphate compound. This result in a particularly good adhesion between the polypropylene composition and the glass filaments. Suitable examples include neopentyl(diallyl)oxy tri(dioctyl) pyrophosphato titanate, cyclo(dioctyl)pyrophosphate dioctyl titanate, dicyclo(dioctyl)pyrophosphate titanate, neopentyl(diallyl)oxy tri(N-ethylenediamineo)ethyl titanate, cyclo[dineopentyl(diallyl)]pyrophosphato dineopentyl(diallyl)zirconate, di(dioctyl)pyrophosphate oxoethylene titanate and the 2-(N,N-dimethylamino)isobutanol adduct of di(dioctyl)pyrophosphate oxoethylene titanate.

Preferably, the amount of C2) with respect to the total amount of B) and C2) is 0.2 to 10 wt %, for example 0.3 to 5.0 wt %, 0.4 to 3.0 wt %, 0.5 to 2.0 wt %.

### D) Low Molecular Weight Polyolefin

The polypropylene composition comprises D) a low molecular weight polyethylene having number average molecular weight of at most 5000 g/mol in an amount of less than 10 wt % with respect to the polypropylene composition. It will be appreciated that this includes the situation where the polypropylene composition does not comprise D) a low molecular weight polyethylene having number average molecular weight of at most 5000 g/mol. If the polypropylene composition comprises D) a low molecular weight polyethylene having number average molecular weight of at most 5000 g/mol, its amount with respect to the polypropylene composition is less than 10 wt %. Accordingly, this feature may also be expressed as “the amount of D) a low molecular weight polyethylene having number average molecular weight of at most 5000 g/mol in the polypropylene composition is less than 10 wt % with respect to the polypropylene composition”.

Preferably, the polypropylene composition is free of or is substantially free of a low molecular weight polyethylene having a number average molecular weight of at most 5000 g/mol. Preferably, the amount of such low molecular weight polyethylene with respect to the polypropylene composition is less than 10 wt %, less than 5.0 wt %, less than 3.0 wt %, less than 1.0 wt %, less than 0.5 wt % or 0 wt %.

Preferably, the polypropylene composition is free of or is substantially free of a low molecular weight polyolefin having number average molecular weight of at most 5000 g/mol. Preferably, the amount of such low molecular weight polyolefin (total of low molecular weight polyethylene having number average molecular weight of at most 5000 g/mol and any other polyolefins having number average molecular weight of at most 5000 g/mol) with respect to the polypropylene composition is less than 10 wt %, less than 8.0 wt %, less than 5.0 wt %, less than 3.0 wt %, less than 1.0 wt %, less than 0.5 wt % or 0 wt %.

### Additives

The polypropylene composition may further comprise additives, such as for example flame retardants, pigments, lubricants, slip agents flow promoters, antistatic agents, processing stabilizers, long term stabilisers and/or UV stabilizers. The amount of the additives may e.g. be 0.1 to 5.0 wt %.

Preferably, the total amount of A), B), C2), D) and the additives is 100 wt % with respect to the polypropylene composition.

### Preferred Compositions

Preferably, the polypropylene composition has a melt viscosity of at most 25 Pa·s, preferably in the range from 1.0 to 25 Pa·s, more preferably in the range from 1.0 to 20 Pa·s, even more preferably in the range from 1.8 to 19.4 Pas or in the range from 1.0 to 15 Pa·s, even more preferably in the range from 1.0 to 10 Pa·s, most preferably 1.0 to 5.0 Pa·s at the melting temperature of the polymer composition, wherein the melting temperature of the polymer composition is determined on a 5 mg sample using a differential scanning calorimetry on the second heating curve using a heating and cooling rate of 10 °C/min and wherein the melt viscosity is determined according to ISO6721-10:2015 by applying oscillating-shear to the molten sample at an Angular Frequency of 1 rad/s and shear strain of 5%.

In some preferred embodiments, the amount of A) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %.

In some preferred embodiments, the total amount of B) and C2) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %.

In some preferred embodiments, the polypropylene composition comprises A) and B). Preferably, the total amount of A) and B) with respect to the polypropylene composition is at least 70 wt %, at least 80 wt %, at least 90 wt %, at least 93 wt %, at least 95 wt %, at least 97 wt %, at least 99 wt % or 100 wt %. Preferably, the amount of A) with respect to the total amount of A) and B) is 1.0 to 30 wt %, for example 2.0 to 25 wt %, 3.0 to 20 wt % or 4.0 to 10 wt %.

In some preferred embodiments, the polypropylene composition comprises A), B) and C2). Preferably, the amount of B) with respect to the total amount of A), B) and C2) is at least 65 wt %. Preferably, the amount of A) with respect to the total amount of A) and B) is 1.0 to 30 wt %, for example 2.0 to 25 wt %, 3.0 to 20 wt % or 4.0 to 10 wt %.

Preferably, the amount of C2) with respect to the total amount of B) and C2) is 0.2 to 10 wt %, for example 0.3 to 5.0 wt %, 0.4 to 3.0 wt %, 0.5 to 2.0 wt %. In particularly preferred embodiments, the amount of A) is 1.0 to 5.0 wt %, the amount of B) is 90 to 98 wt %, the amount of C) is 1.0 to 5.0 wt %, with respect to the total amount of A), B) and C).

In particularly preferred embodiments where the polypropylene composition comprises A), B) and C2), C1) is selected from the group consisting of anhydrides (e.g. maleic anhydride, itaconic anhydride) and C2) comprises an organometallic compound having a pyrophosphate group, preferably a titanate pyrophosphate compound or a zirconate pyrophosphate compound.

### Further Aspects

The invention further provides a multifilament strand comprising a plurality of the coated glass filaments according to the invention which are bundled. The multifilament strand may further comprise non-coated glass filaments, but preferably at least 50 wt %, at least 60 wt %, at least 70 wt %, at least 80 wt %, at least 90 wt %, at least 95 wt %, at least 98 wt %, at least 99 wt % of the multifilament strand is the coated glass filaments according to the invention.

The invention further provides pellets of a glass fiber-reinforced thermoplastic polymer composition comprising a sheathed continuous multifilament strand comprising a core that extends in the longitudinal direction and a polymer sheath which intimately surrounds said core, wherein the core comprises the glass multifilament strand according to the invention.

The length of the glass filaments in the pellets may be substantially the same as the pellet length, and is 10 to 55 mm, preferably 10 to 40 mm, more preferably 10 to 30 mm and most preferably from 10 to 20 mm. Such pellets can be obtained by applying the polymer sheath of a thermoplastic polymer composition comprising a polyolefin around the core and cutting the sheathed continuous multifilament strand, as described e.g. in WO2009080281A1 and WO2022128783A1.

In the pellets, the amount of the glass filaments may e.g. be 60 to 95 wt %, e.g. 70 to 90 wt % with respect to the pellets.

It is noted that the invention relates to the subject-matter defined in the independent claims alone or in combination with any possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### Experiments

Samples of polymer compositions were prepared from the components of Table 1 as follows: If all components are solid, powder blends were made by mixing the powders in a plastic bag, polymers in pellet shape were powdered by cryogenic grinding. In case of liquid additives, the additive was dissolved in an appropriate solvent, spread out over powdered polypropylene (PP) and the solvent was allowed to evaporate overnight in a fume hood after which the powder with additive was mixed well by shaking in a plastic bag.

The so formed mixture was added by means of a loss-in-weight feeder at 300 g/h to a Thermo Scientific Process 11 (P11) 11 mm diameter, twin-screw, corotating extruder twin screw extruder with an L/D of 45 having as crew built up with transportation elements and 3 sections of kneeding elements at a speed of 250 rpm and the barrel having 8 heating sections set at 40, 120, 180, 200, 200, 200 and 200 °C, the die set at 200 °C. The extrudate was cooled in a water bath with running tap water and pelletized.

### IFSS Measurement (Interfacial Shear Strength)

Samples of coated glass filaments were prepared from the pellets and the interfacial shear strength was determined by the Microbond test described in L. Yang & J. L. Thomason: Development and application of micromechanical techniques for characterising interfacial shear strength (IFSS) in fibre-thermoplastic composites—Polymer Testing 31 (2012) 895-903). The pellets of the composition obtained above were molten and a filament was drawn from the melt. A loose knot was made from the filament and one glass filament was placed in the loose knot. The knot was tightened and excess of the PP filament was cut away, resulting in a small knot of PP filament around the glass filament. This was heated under nitrogen to melt the PP composition, forming a droplet of the PP composition around the filament. After cooling, the droplet was solidified. The glass filament was pulled out to determine the interfacial shear strength.

In CE1, the polymer composition was applied to glass filaments provided with an aminosilane sizing composition optimized for adhesion to PP. In CE2-CE4, E5, RE6-RE7, E8-E19, the polymer composition was applied to glass filaments without any sizing composition, supplied by Fibrecoat GmbH.

### Materials:

### A)

C1) type MAH: Exxelor P01020 from Exxon Mobil, polypropylene grafted with maleic anhydride (0.9 wt % anhydride)
C1) type ITA: Scona TSPP 8219 GA from BYK Chemie GmbH, polypropylene grafted with itaconic anhydride (2 wt % anhydride)
C1) type epoxy: Scona TPPP 8104 FA from Chemie GmbH, polypropylene grafted with glycidyl methacrylate (2.5 wt % glycidyl methacrylate)

### B)

PP595A from SABIC, propylene homopolymer having MFR according to ISO1133 at 230 °C and 2.16 kg of 47 dg/min

### C2)

PA: Radipol S24HA from Radicii Group, polyamide 6
PE-HEMA: poly(ethylene-hydroxyethylmethacrylate) containing 12 wt % of hydroxyethylmethacrylate
vinyl-oligosilane: Silquest G-170 from Momentive Performance Materials aminopropyl-oligosilane: Silquest VX-225 from Momentive Performance Materials
acryloxy-oligosilane: Silquest A-274 from Momentive Performance Materials titanate pyrophosphate: Ken-React LICA 38 from Kenrich Petrochemicals, Inc., neopentyl(diallyl)oxy tri(dioctyl)pyrophosphate titanate

The compounds mentioned above as C2) have a hydrogen atom capable of forming hydrogen bond or have a functional group which generates a hydrogen atom by (partial) hydrolyzation of the group.

### Others

EVA: poly(ethylene-vinylacetate) containing 10 wt % of vinylacetate zirconate phosphate: Ken-React ZN 12 from Kenrich Petrochemicals, Inc.,
isooctanol hydrogen phosphate zirconium complex

The compounds mentioned above as Others do not have a hydrogen atom capable of forming hydrogen bond and do not have a functional group which generates a hydrogen atom by (partial) hydrolyzation of the group.

### Other Measurement Methods

### Melt Viscosity

Melt viscosity was measured in accordance with ISO6721-10:2015 on either pellets or extruded pieces that are inserted in the plate-plate oscillatory-shear rheometer. A MCR 502 rotational rheometer from AntonPaar was used. The sample was molten inside the 25 mm diameter test-geometry at the measurement temperature (oven set to 250 °C or 290 °C) and the sample was preheated in the oven for 1 minute to obtain a completely molten sample and trimmed to a 1 mm gap, after which oscillating-shear was applied with an Angular Frequency of 1 rad/s and shear strain of 5%. During this test the melt viscosity was monitored as a function of time.

Standard linear propylene homopolymers (with different melt flow rates) were used to calibrate the rheometer.

### Melting Temperature

The melting temperature is determined by differential scanning calorimetry using the second heating curve, wherein the first heating rate is 10 °C/min, the first cooling rate is 10 °C/min, the second heating rate is 10 °C/min, and the sample weight is 5 mg.

### Mn and Mw

5 mg of sample is dissolved in 10 ml of 1,2,4-trichlorobenzene at 160 °C. The vial is placed in the Polymer Char GPC and processed automatically.

The following critical parameters are applied:
Chromatography: PolymerChar GPC-IR system running at 160 °C
Detection: Polymer Char IR5 infrared detector; PolymerChar viscometer
IR5 is used as concentration detector.
Column set: three Polymer Laboratories 13 μm PLgel Olexis, 300×7.5 mm
PE molar mass calibration was performed with linear PE standards (narrow and broad (Mw/Mn=4 to 15)) in the range of 0.5-2800 kg/mol
Concentration of samples injected are 0.03% m/m stabilized with Irgafos 168 and Topanol CA (weight ratio sample: Irgafos: Topanol=1:1:1)
Solvent and Eluent is 1,2,4-trichlorobenzene stabilized with 1 g/L BHT.

TABLE 1

| | | | B) | | C2 | | |
|---|---|---|---|---|---|---|---|
| | A) (wt %) | C1) type | (wt %) | C2) type | (wt %) | Others | IFSS [MPa] |
| CE1 | 3 | MAH | 97 | | | | 23 |
| CE2 | | | 100 | | | | 7.1 |
| CE3 | | | | | | EVA | 6.3 |
| | | | | | | (100 wt %) | |
| CE4 | | | 99 | | | zirconate | 8.6 |
| | | | | | | phosphate | |
| | | | | | | (1 wt %) | |
| E5 | 100 | MAH | | | | | 25.3 |
| RE6 | | | | PA | 100 | | 12.6 |
| RE7 | | | | PE-HEMA | 100 | | 10.2 |
| E8 | | | 92 | vinyl-oligosilane | 8 | | 15 |
| E9 | | | 99 | titanate | 1 | | 13 |
| | | | | pyrophosphate | | | |
| E10 | | | 96 | vinyl-oligosilane | 4 | | 14.2 |
| E11 | 100 | ITA | | | | | 24.5 |
| E12 | 100 | epoxy | | | | | 11.8 |
| E13 | 3 | MAH | 97 | | | | 15 |
| E14 | 10 | MAH | 90 | | | | 14.9 |
| E15 | 20 | MAH | 80 | | | | 16.8 |
| E16 | 3 | MAH | 96 | titanate | 1 | | 20.2 |
| | | | | polyphosphate | | | |
| E17 | 3 | MAH | 93 | vinyl-oligosilane | 4 | | 13.3 |
| E18 | 3 | MAH | 93 | aminopropyl- | 4 | | 10.5 |
| | | | | oligosilane | | | |
| E19 | | | 96 | acryloxy- | 4 | | 11.4 |
| | | | | oligosilane | | | |

In CE1, the glass filaments with the sizing composition coated with a composition comprising polypropylene grafted with maleic anhydride resulted in a high IFSS.

CE2 shows that application of polypropylene to glass filaments without sizing composition results in a low IFSS, lower than 10 MPa.

Comparison of CE3 to CE4 versus CE2 shows that the use of compounds that do not have a hydrogen atom capable of forming hydrogen bond and do not have a functional group which generates a hydrogen atom by (partial) hydrolyzation of the group still results in a low IFSS, lower than 10 MPa.

Comparison of E5, RE6, RE7 and E8 to E19 versus CE2 shows that the use of compounds that have a hydrogen atom capable of forming hydrogen bond or have a functional group which generates a hydrogen atom by (partial) hydrolyzation of the group results in a high IFSS, exceeding 10 MPa.

ILSS of bare glass filaments to pure anhydride grafted PP is very high (E5 and E11), even exceeding that of sized glass filaments with PP/PP-g-MAH 97/3 resin (CE1).

Diluting PP-g-MAH in PP homopolymer decreases ILSS values (E13-E15), but even dilution to 3 wt % PP-g-MAH (E13) still results in a relatively high ILSS. The effect of epoxy grafted PP is lower than anhydride grafted PP (E12 versus E4 and E11).

The addition of an oligosilane to PP results in a high ILSS (E8 and E10 versus CE2). When comparing different types of oligosilanes, aminopropyl-oligosilane in combination with PPMAH (E18) has the lowest effect. The acryloxy-oligosilane (E19) has a slightly higher effect and the vinyl-oligosilane (E10) has a considerably higher effect. Increasing the vinyl-oligosilane level to 8 wt % resulted in a slight increase (E8).

The addition of both oligosilane and a grafted PPMAH to PP does not have a large effect in ILSS. The addition of both results in a lower ILSS than the addition of either of the two separately (E17 versus E10, E17 versus E13).

The addition of a titanate pyrophosphate results in a high ILSS (E9 versus CE2). The addition of both titanate pyrophosphate and a grafted PPMAH to PP results in a large increase in ILSS. The addition of both results in a higher ILSS than the addition of either of the two separately (E16 versus E9, E16 versus E13).

Specific interactions via alcohol or amine/amide groups lead to higher values of ILSS, but still on the low end of all samples tested, RE6 and RE7.

1. A coated glass filament comprising a glass filament and a coating layer of a polypropylene composition provided directly on the glass filament, wherein the polypropylene composition comprises
A) a grafted polypropylene grafted with C1) a side chain compound capable of forming hydrogen bond and/or
B) a non-grafted polypropylene and C2) a compound capable of forming hydrogen bond,
wherein the polypropylene composition comprises D) a low molecular weight polyethylene having number average molecular weight of at most 5000 g/mol in an amount of less than 10 wt % with respect to the polypropylene composition,
wherein the total amount of A) and B) with respect to the polypropylene composition is at least 90 wt %.

2. The coated glass filament according to claim 1, wherein the polypropylene composition comprises A) and B).

3. The coated glass filament according to claim 1, wherein the polypropylene composition comprises B) and C2).

4. The coated glass filament according to claim 1, wherein the polypropylene composition comprises A), B) and C2).

5. The coated glass filament according to claim 1, wherein C1) is selected from the group consisting of anhydrides, vinyl-oligosilane, acryloxy-oligosilane, epoxy (meth)acrylates and combinations thereof.

6. The coated glass filament according to claim 1, wherein C1) is selected from the group consisting of anhydrides.

7. The coated glass filament according to claim 1, wherein C2) is selected from the group consisting of oligosilanes, a copolymer of ethylene and 2-hydroxyethyl methacrylate, epoxy (meth)acrylates, polyamides, an organometallic compound having a pyrophosphate group and combinations thereof, wherein in the absence of C1), C2) is selected from the group consisting of vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

8. The coated glass filament according to claim 1, wherein C2) is selected from the group consisting of vinyl-oligosilane, acryloxy-oligosilane, an organometallic compound having a pyrophosphate group and combinations thereof.

9. The coated glass filament according to claim 1, wherein the polypropylene composition comprises A), B) and C2), wherein
C1) is selected from the group consisting of anhydrides and
C2) comprises an organometallic compound having a pyrophosphate group.

10. The coated glass filament according to claim 1, wherein the polypropylene composition comprises an alkoxysilane compound having molecular weight of less than 300 in an amount of less than 10 wt % with respect to the polypropylene composition.

11. The coated glass filament according to claim 1, wherein the total amount of A) and B) with respect to the polypropylene composition is at least 93 wt %.

12. The coated glass filament according to claim 1, wherein
the amount of C1 with respect to the amount of A) is 0.5 to 10 wt %, and/or
the amount of C2 with respect to the total amount of B) and C2) is 0.2 to 10 wt %.

13. The coated glass filament according to claim 1, wherein the glass filament has been obtained by removing polymer from a polymer coated glass filament.

14. A multifilament strand comprising a plurality of the coated glass filaments according to claim 1 which are bundled.

15. Pellets of a glass fiber-reinforced thermoplastic polymer composition comprising a sheathed continuous multifilament strand comprising a core that extends in the longitudinal direction and a polymer sheath which intimately surrounds said core,
wherein the core comprises the glass multifilament strand according to claim 14.
